(19) United States
(12) Patent Application Publication
(10) Pub. No.: US 2005/0014042 A1
(43) Pub. Date: Jan. 20, 2005

(54) Apparatus for controlling a fuel cell device, and a fuel cell device

(76) Inventors: Frank Brenner, Remseck (DE); Ulrich Gottwick, Stuttgart (DE); Martin Moeller, Stuttgart (DE); Rainer Saliger, Bamberg (DE); Jan-Michael Graehn, Stuttgart (DE)

Correspondence Address: STRIKER, STRIKER & STENBY, 103 East Neck Road, Huntington, NY, 11743, US

(21) Appl. No.: 10/890,582

(22) Filed: Jul. 14, 2004

(30) Foreign Application Priority Data
Jul. 17, 2003 (DE) 103 32 518.2

(51) Int. Cl. H01M 8/04; H01M 8/12

(52) U.S. Cl. 429/22; 429/23

(57) ABSTRACT

An apparatus for controlling a fuel cell device for energy supply in a finished end product has a control unit for an operation of the fuel cell device, the control unit being formed so as to control control operational points in predetermined phases during the operation and to obtain an adjustable value of at least one device variable of the fuel cell device and to evaluate it with respect to at least one previously determined value of the device variable of the fuel cell device.

### BACKGROUND OF THE INVENTION

The present invention relates to an apparatus for controlling a fuel cell device, as well as to a fuel cell device.

In the fuel cell technology fuel cells are used as electric current sources. By electrochemical oxidation of an oxidizable substance, chemical energy is converted into electrical energy in fuel cell devices. Basically, a fuel cell unit can be formed as a single fuel cell, and also as an electrical and/or electrochemical circuit of several individual cells, or a so-called fuel cell stack. Subsequently, the term “fuel cell” can be used to identify a fuel cell stack, unless indicated otherwise. In addition to the electrical circuit, a structure is provided in a fuel cell unit or in a fuel cell stack, which serves for supply of the electrodes with educts and withdrawal of products. A fuel cell device which is subsequently identified as FCD, includes, in addition to the fuel cell stack, also peripheral components, such as for example for gas supply, for heat management, and for regulation and control of the FCD.

In many applications of FCD they are provided for example for vehicle drive or a so-called auxiliary power unit (APU), for example as additional current sources or as a replacement for a generator or light device in mobile applications for providing energy or in stationary systems, such as for example fuel cell heating power plants. For a production ready condition, the reliability and monitoring and safety of the FCD are however not sufficient.

### SUMMARY OF THE INVENTION

Accordingly, it is an object of the present invention to provide an apparatus for controlling a fuel cell device, as well as a fuel cell device, in which the reliability or the monitoring and safety of the FCD are increased, and a serious production use of the FCD in particular in mobile applications, for example in the land, air and water vehicles is possible.

In keeping with these objects and with others which will become apparent hereinafter, one feature of the present invention resides, briefly stated, an apparatus for controlling a fuel cell device for energy supply in a finished end product, comprising control means for an operation of the fuel cell device, said control means being formed so as to control operational points in predetermined phases during the operation and to obtain an adjustable value of at least one device variable of the fuel cell device and to evaluate it with respect to at least one previously determined value of the device variable of the fuel cell device.

Another feature of the present invention resides, briefly stated, in an energy supply system for a finished end product formed as a vehicle with a fuel cell drive, comprising a fuel cell device; and an apparatus for controlling the fuel cell device, said apparatus including control means for an operation of the fuel cell device, said control means being formed so as to control operational points in predetermined phases during the operation and to obtain an adjustable value of at least one device variable of the fuel cell device and to evaluate it with respect to at least one previously determined value of the device variable of the fuel cell device.

In correspondence with the present invention, an apparatus is provided for controlling a fuel cell device formed for the energy supply in a final end product and including control means for the operation of the fuel cell device. The control means are designed for this purpose so that the control operational points are controlled in a predetermined phases during the operation, and one adjusting value of at least one device variable of the fuel cell device is picked up and evaluated with respect to at least one previously determined value of the device variable of the fuel cell device.

For adapting safety requirements for the utilization of hydrogen to the FCD, they must be regularly checked during the operation with respect to operability and reliable error recognition. In the vehicles operational tests are known for safety systems, such as for example antiblocking systems, electrohydraulic brakes, airbags, etc. So-called on-board-diagnosis features for monitoring the fuel cell device, for example in the vehicles are not known for a series production applications.

In accordance with the present invention, a system for FCD is provided, with which the reliability or monitoring and safety of the FCD is significantly increased. The controlling of the control operational points is performed in selected phases of the operation, in particular however not over the total or approximately total operational time. Such operational phases are for example the starting phase or also idle running, constant operation or post running phases. In these phases the control can be performed simply, since the FCD is subjected to constant or relatively low loads. The control of control operational points takes place preferably at different time points or many times over the total operational time of the FCD. Thereby system changes are recognized and evaluated at an early time. Operational disturbances due to the device errors which are not detected or detected too late and which negatively effect for example the reliability of the user of the FCD, are avoided in advantageous manner.

The device variables can include all possible parameters of an FCD, in particular the parameters with relevant for the method, such as for example temperature, pressure, material concentrations and flows, electrical parameters such as voltage or current intensity, and other parameters which are important for the operation of the FCD.

In addition to the control means, advantageously no other components of the FCD are needed which are additional to the components of a conventional FCD. In particular, the device control is performed automatically, or in other words the control and subsequent processing of the adjustable device variables. In an FCD in accordance with the present invention which is used in automobiles, when the driver releases the drive, for example by turning the ignition key in the ignition lock before or in a starting phase, an inventive control can be released.

It is especially advantageous when for example the post-equipment of a conventional FCD is performed with an inventive control device to involve low expenses. In this case, for example a corresponding programming of the variable control means of the FCD can be performed, for implementing the inventive apparatus in the FCD. Alternatively, the available conventional control means of the FCD can be replaced with inventive control means, for example, by exchanging a computer unit. Alternatively, the inventive control means can be provided additionally to it in the component of the FCD or in the final product, to be used in a first line or exclusively in accordance with the present invention.

The control operational points include all possible operational conditions reachable in the FCD. For controlling the control points, in particular the important or for the safety of the system relevant components of an FCD are controlled. Such components include for example the components which influence the system pressure in the supply conduits or discharge conduits from the fuel cell or anode-or cathode-side in the fuel cell, for example compressors, pressure regulators, pressure reducers, supply, return or withdrawal valves, etc.

With the valuable detection and evaluation of at least one device variable which sets as a response to the control or regulation of the control operational points, a targeted judgment of the reaction of the FCD to the control is performed. In order to obtain an extensive judgment of the reaction of the FCD to the control of the control operational points, with the control of an operational point also several device variables which can be possibly changed by the control can be detected and evaluated. In principle, after the control or regulation of the control operational points, a time period, that can be variable, can be provided for detection or evaluation of the adjustable device variables.

In an especially advantageous embodiment of the present invention, the control means are provided for controlling the control operational points, which do not occur in a conventional operation or occur only relatively seldom. Advantageously, in such operational points, for example certain errors or interferences can be recognized especially reliably or they are detectable exclusively in these control operational points.

In accordance with a preferable embodiment of the present invention, the control means operate so that, during an evaluation the at least one adjustable value of at least one device variable is compared with the at least one previously determined comparison value of the device variable.

The comparison evaluation allows an accurate error identification. With the determination of comparison values, which for example are stored in an electronic unit of the FCD, considerations for example with respect to the configuration or management of the device can be taken into consideration. In the sense of the present invention, the comparison with a comparison value, can involve, in addition to the comparison with an individual value, also a comparison with a value region.

For taking into account the reaction of the FCD to the control of the control operational points, in addition to an evaluation of an individual value of a device variable, also a plurality of values can be evaluated or obtaining or evaluation of values which is continuous over time can be performed. In particular, the continuous evaluation allows an exact consideration of the reaction of the FCD to the control of the control operational points and thereby an especially expressive error recognition.

For a preferable embodiment of the present invention, it is proposed to design the control means so that in the case of deviation of at least one adjustable value from the at least one comparison value of the device variable, a corrective measure which is determined for the deviation is performed. The control of control operational points is performed in accordance with the present invention sufficiently frequently over the time of the operation, so that as a rule it can occur at proper time before an error, to perform a corresponding corrective measure. If a corrective measure is not possible or is not efficient, the failure is identified for information or as a hint for a required repair to the user. The corrective measure as a rule is released only in case of the deviation of the value obtained by the evaluation, from the comparison value. As corrective measures, depending on the type and magnitude of the deviation of the value, different steps are possible. These corrective measures include some features which actively act on the components of the FCD. They include for example spraying steps, pressure adaptation or changes activating the moisturizing of the fuel cell diaphragm. With less critical errors or additionally also passive steps can be considered, such as for example a protocolling and/or storage of the errors or an indication of the error, for example optically or acoustically to the user of the manufactured product.

In a preferable embodiment of the present invention, the control means are designed so that the control operational points are controlled one after another in a predetermined sequence. For example, a selection of certain operational points, for example in correspondence with their safety relevance or all possible operational points for control can be controlled one after the other, and in some cases also repeatedly controlled at a later time point. When preferably the device is tested with respect to its operability and safety at different time points or repeated many times over the total operational time of the FCD.

In accordance with a preferable design of the inventive control means, the control means are designed so that with deviation of the at least one adjustable value from the comparison value, a control of one or several further control operational points is maintained or a control of new control operational points is performed. Thereby it can be provided that only the control operational points are controlled, that can be controlled or judged with a known error. Moreover, a possible danger to the user or a negative influence of the total system can be avoided when for example a known error can lead to a dangerous situation with a control of a further control operational point. An error recognition can preferably activate also a change of the sequence of the subsequent controls of the control operational points. Additional control operational points which were not controlled without the performed error recognition can be then controlled. With these variants, for example the faulty components can be found from many in question and can be exactly localized, which frequently is possible only by the control of several different control operational points one after the other. Moreover, also further errors which depend on the recognized error can be determined as well.

In accordance with the present invention, it is further proposed that the control means run to the control operational point so that the action possibilities provided in the final product on the fuel cell device by the user of the final product are not negatively affected by the control of the control operational points. The inventive control means secure a continuous intervention possibility for the FCD by the user. In particular, it is avoided that this can come in critical situations, in that for example the action on the relevant or controlled components by the automatic control of the control operational points is limited or completely blocked. In ideal case, a user does not perceive the control of the control operational points or perceives it as information about the status of the control of the error recognition. Alternatively, the control of the control operational points can be performed in accordance with priority, without controlling the FCD during this time by the user, for example by a short-term blocking of the operational possibilities of the gas pedal in the starting phase.

In accordance with an advantageous design of the present invention, the control means for running into such operational points are formed so that with the action possibilities provided by the user in the final product the fuel cell device can not be controlled. In many cases errors are to be detected only in extreme operational points. Such operational points can be undesirable in a conventional meaning when for example they are not economical, but controlled in accordance with the present invention over a short time as a control operational point by the control means for testing and safety reasons.

Furthermore, an FCD with the above described device is proposed. Such an FCD is especially advantageous when the inventive control means are integrated in the control means provided for the operation of the FCD. For this purpose the available control means for example are configured correspondingly by a programming process. The available control means can be also replaced by a unit formed in accordance with the present invention and connected to the previously provided control means through available interfaces of the FCD for the previously provided control means. Also an additional control unit can be provided, for example a control chip which is integrated in the available control means. Alternatively, the inventive control means can be provided as an additional component, in addition to the available control means. These different possibilities allow a simple and efficient way to equip the available FCD with the inventive control means or to incorporate the same into a new FCD.

Also, with the inventive FCD it is proposed that the additional components for controlling the control operational points can be available, in which the fuel cell produces a predetermined current quantity. Such an FCD has the advantage that it is determined for the cooperation with the inventive control means so that a general system test is possible for testing the capacity of the fuel cell. Such inventive system tests are especially expressive and reliable, since for supplying a predetermined current quantity through the fuel cell, almost all components or all substantial components of the fuel cell or the FCD must be in an error-free condition. This is reinforced especially advantageously when in the control operational point a high current quantity is produced by the fuel cell, for example which the FCD is connected to a high load over a short time. A reaction of the FCD is produced and for example evaluated as to its value. For this purpose for example an additional component is needed, with which a relatively low electrical resistance is applied to the consumer side of the fuel cell, and thereby a high load demand is provided. In addition to electronic components, also some mechanical components or sensor means can be provided as well.

The additional components are in particular such components, which are not provided in the conventional FCD. Such additional components can be provided for a targeted control of the control operational points in which the fuel cell produces a predetermined current quantity. Individual or all required components for its functions can be integrated in the available components of a conventional FCD, and thereby an adaptation of the conventional FCD to the inventive embodiment can be performed in a relatively simple manner.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing parts of an FCD with important components without an electronic unit;

FIG. 2 shows an example a measured curve course, which is obtained by controlling several control operational points and an upper and a lower limiting curves, represented in a coordinate system, wherein the electrical current is plotted over the abscissa axis and the electrical voltage of a fuel cell or a fuel stack is plotted over the ordinate axis;

FIGS. 3a and 3b show as an example corresponding measured curved courses of the pressure on the anode and on the cathode of a fuel cell in test phases a to i, that are obtained during the control of control operational points and obtaining or evaluating of the adjusted pressure on the anode and the cathode, shown in a coordinate system, wherein the time is plotted on the abscissa axis and the pressure on the anode (see FIG. 3a) or the pressure on the cathode (see FIG. 3b) is plotted on the ordinate axis.

### DESCRIPTION OF THE PREFERRED EMBODIMENTS

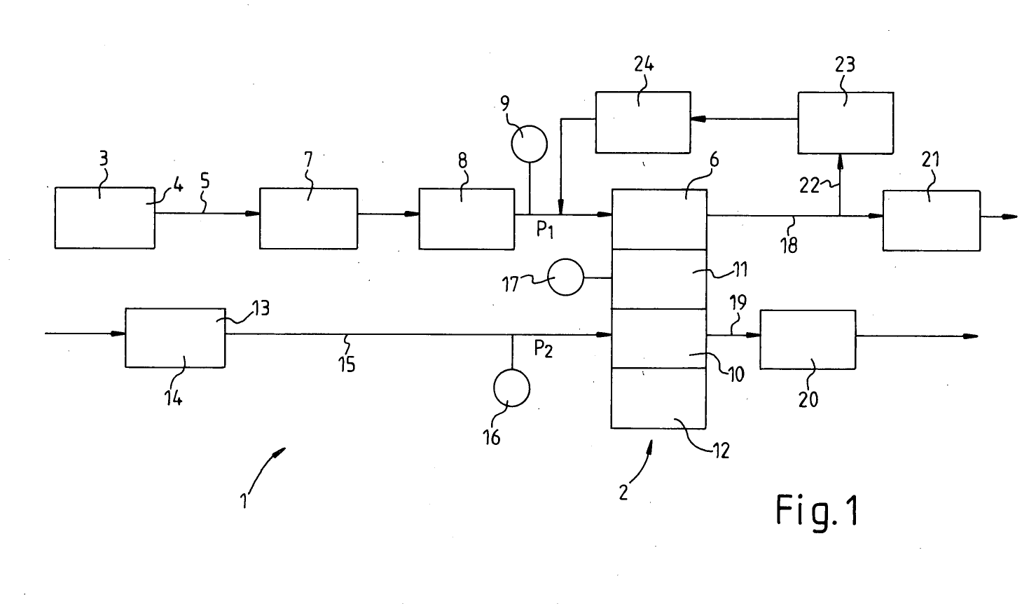

FIG. 1 shows schematically parts of an FCD 1 with a fuel cell FC 2 and further important components which are identified by rectangular boxes or by circles, for example for sensor means. A substance to be oxidized, for example hydrogen 4 is stored in a tank 3 which as a rule has a pressure approximately 350 bar, in some cases also substantially higher up to 700 bar. Depending on a demand, it is supplied through a supply 5 to an anode 6 of the fuel cell 2. FIG. 1 schematically identifies the paths of material streams in the FCD by corresponding arrows.

At least one pressure reducer 7 is arranged in the supply 5 after the tank 3, and a pressure regulator 8 is integrated further in a flow direction. The pressure reducer 7 regulates the hydrogen pressure in the tank 3 for example from approximately 350 bar down to for example approximately 10 bar. Depending on the operational conditions the pressure regulator 8 lowers this pressure level on the anode side 1 bar to 3 bar. Moreover, a pressure sensor 9 in the supply 5 in the flow direction after the pressure regulator increases the pressure P₁ before the FC 2 on the anode side.

Through a further supply 15 to the FC2, for example by a compressor 14, an oxidation agent 13, as a rule air or oxygen or an oxygen-containing gas mixture, is supplied under pressure to a cathode 10 of the FC. In the supply 15, a pressure sensor 16 measures the pressure P₂ of the compressed oxidation agent 13.

A diaphragm 11 is located between the anode 6 and the cathode 10. A heat exchanger 12 serves for regulation of the temperature of the FC2 or a fuel cell stack. The diaphragm 11 which can have for example a thickness of 50-200 μm, can be formed for example as a polymer-electrolyte diaphragm. Other diaphragms however are also suitable. At least one temperature sensor 17 is provided for a temperature pickup in the FC2.

The drawings do not show further components of the FCD, such as for example further sensors, for example tank sensors for pressure, feeling degree, etc., control means of the FCD, and associated supply and discharge conduits, through which the control means are connected with components of the FCD or other units of a final end product, in which the FCD is integrated. The control means can be connected for example with the components of the FCD 1 shown in FIG. 1, for controlling the control operational points. When further components are provided in the FCD 1, then by the targeted control of these components, the action of the system can be monitored.

An anode-side discharge 18 and a cathode-side discharge 19 are provided for gas withdrawal from the FC2. A dynamic pressure regulator 20 is arranged in the discharge 19. The discharge 18 serves as a ventilating valve 21 for an anode-side ventilation of the FC2.

A bypass conduit 22 branches in the discharge 18 from the ventilating valve 21. A partial stream of the gas discharged at the anode side from the FC2 can be supplied through the bypass conduit 22 back into the supply 5 before the anode 6. A so-called recirculation valve 23 and a recirculation pump 24 are arranged in the bypass conduit 22 for the gas return.

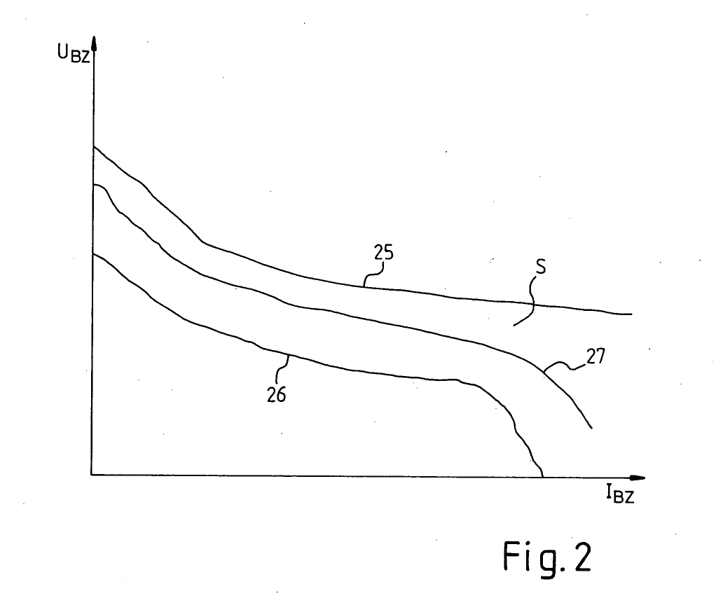

FIG. 2 shows a portion of a coordinate system, wherein the electrical current I_{FC} is plotted over the X-axis and the associated electrical voltage U_{FC} of a fuel cell or a fuel cell stack is plotted over the Y-axis. An upper current/voltage limiting line 25 and a lower current/voltage limiting line 26 of the FC2 are shown in this coordinate system. Both limiting lines 25 and 26 limit an allowable region S for the interelationship of the current I_{FC} and the voltage U_{FC} for the FC2. Both limiting lines 25, 26 are based on previous research or experience values. In their course and in their absolute values they substantially depend on the operational parameters of the FC2, for example on the stack temperature or the system pressure or on air or oxygen excess in the fuel cell 2. The lower limiting line 22 corresponds for example to relatively low anode-or cathode-side pressures or low stoichiometries of the reaction partners which contribute to the electrochemical process. The upper limiting line 25 represents to the contrary the considered reaction partners with relatively high pressures or high stoichiometries.

In order to take into consideration age-related device degredations during the evaluation of the device variables and in order not to identify the age-dependent device degredations as errors, the comparison values or curves can be correspondingly adapted, for example with an operational hour counter for displacement, evaluation, or narrowing of the comparison values or curves. For example, with the time due to wear, the loss flows through leakage at the compressor increase, which however must not lead to any error recognition. This can be taken into consideration by an adaptation of the monitoring limits. For this purpose the monitoring limits initially can be narrower and later can be broader. The error recognition is improved in that the limits must not contribute from the beginning to all tolerances over the service life.

For system control of the FCD 1, it is connected for a short time by the control means, for example to a relatively high load. During the test through the sensor means, a current/voltage characteristic line 27 of the fuel cell 2 is measured. The obtained characteristic line, which is a so-called polymerization curve 27, is compared with the upper or lower current/voltage limiting lines 25, 26, provided as functions of the operational parameters (for example pressure, temperature, stoichiometries on the anode-or cathode side). If the measured characteristic line 27 is located in the allowed region S between the lower and upper limiting lines 25, 26, the FC2 operates without error. In the case of deviation of the measured characteristic line 27 from the allowed region S, one or several corrective measures are introduced, for example rinsing processes, pressure adaptation, changes of moisture of the diaphragm, etc. When the characteristic line 27 or the measuring operational point is located above the upper current/voltage characteristic line 25, this is preferably related to faulty sensors.

For adjusting the upper or lower limiting lines, in particular model calculations have to be performed. The signals of the sensors provided for this purpose are transmitted to the control unit of the FCD1 and further processed in the model computations. For this purpose at least two operational parameters must be taken. In principle for the system control of the FCD1, at least two operational variables have to be determined, for example one non-electrical variable, such as pressure, temperature or stoichiometries on the anode-or cathode side, and an electrical variable, such as for example the current intensity or the voltage.

The characteristic line 27 is continuously detected with a variable load, as shown in FIG. 2. Instead of the characteristic line 27, also a punctual detection in one or several individual values is possible, for example before and after connection of discrete load points.

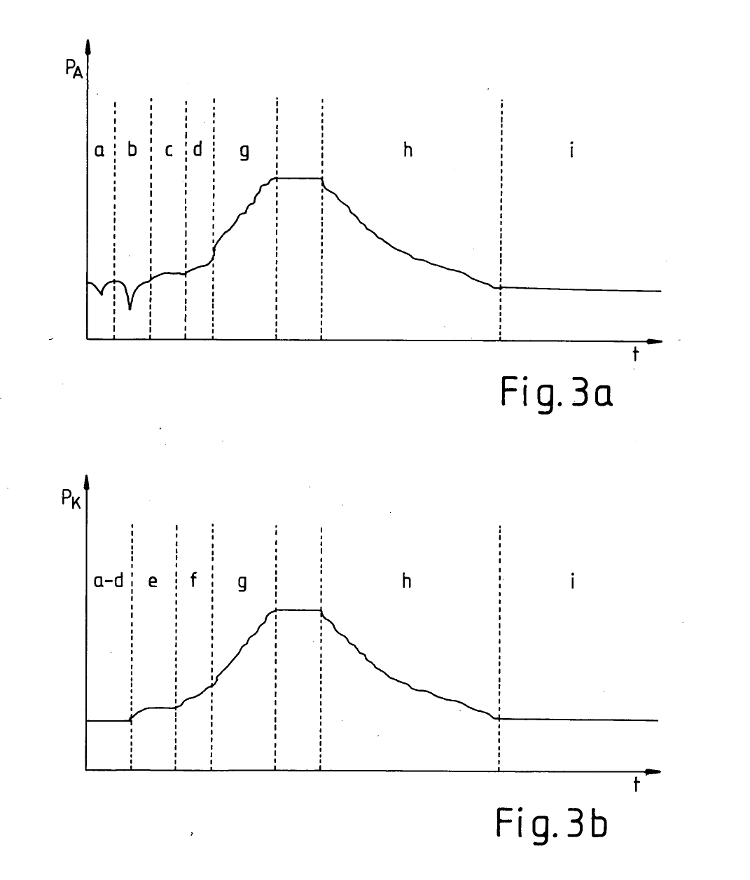

FIGS. 3a and 3b show in an exemplary fashion in the test phases a to i a measured curve course of the pressure p_{A} on the anode and the pressure p_{K} on the cathode of the fuel cell 2, which are taken during the control of the control operational points. After each control, a retention time is planned, and the adjustable condition is monitored for plausibility within the limits. These testing phases a to i are characterized as follows:
a: No anode-side components are controlled. The anode pressure p_{A} increases in correspondence with the stack power discharge. After the evaluation of the device response, the nominal pressure in some cases is again set, which leads to a pressure increase on the anode 6 substantially to the initial level. In accordance with the invention, the control of a control operational point can include also the simultaneous stop of the control of selected components.
b: Control of the ventilation valve 21 leads to an anode pressure decrease. After the evaluation of the device response the nominal pressure on the anode 6 is in some cases again set.
c: Control of the pressure regulator 8 without a control of the pressure reducer 7. The anode-side pressure PA can be maintained with the stack power discharge only so long, until the pressure in the volumes between the pressure regulator 8 and the pressure reducer 7 is taken off to p_{A}, and then the pressure p_{A} decreases under the nominal value.
d: Pressure buildup on the anode 6 in correspondence with the regulating circuit of the pressure regulator 8 and the pressure reducer 7 in accordance with the nominal value guideline in the operation of the FCD1.
The pressure course in the test phases a-d on the cathode 10 remains constant through the regulating circuit of the compressor 14 and the dynamic pressure regulator 20.
e: At the cathode side the pressure 14 is controlled with the open dynamic pressure regulator 20. An increase of the cathode pressure p_{K} to the pressure level of the open dynamic pressure regulator 20 is recognized, on which the pressure p_{K} then remains constant.
f: The control of the pressure 14 and the setting of the cathode pressure p_{K} with the dynamic pressure regulator 20 leads to a controllable pressure increase.
g: A system pressure increase is obtained on the cathode side by the regulating circuit of the compressor 14 and the dynamic pressure regulator 20 or on the anode side by the regulating circuit of the pressure regulator 8 in accordance with the nominal characteristic line. A system pressure increase is obtained at the cathode side by the regulating circuit of the compressor 14 and the dynamic pressure regulator 20 or on the anode side by the regulating circuit of the pressure regulator 8 according to the nominal characteristic line. This testing phase corresponds to an all-inclusive system test with a load increase.
h: With power decrease by a consumer or with the above described connection of a high load for obtaining the characteristic line 27 from FIG. 2, an anode-side pressure reduction is performed. A corresponding pressure drop on the cathode side is set by the regulating circuit of the compressor 14 and the dynamic pressure regulator 20.
i: By targeted thermomanagement operation, or in other words for example by a change in the cooling circuit of the heat exchanger 12, the temperature in the stack is changed, and compared with a temperature course in the stack to be expected (not shown). A pressure change in the FC system in the shown case is not determined.

In the test phases a-i the obtained pressures p_{A}, p_{K} or their courses over the time t are subjected to a comparison with the comparison values. In the case of deviation, for example from the allowable region, an error is recognized and therefore a predetermined correction measure is introduced. The previously determined comparison pressures or upper and lower comparison curves of the pressure are not shown in FIGS. 3a and 3b.

In all testing phases in conditions which negatively influence the operability of the FCD, the testing phases are interrupted. An interruption criteria is for example an exceeding of a maximum allowable pressure difference between anode-and cathode sides, for example of 50 kPa.

It will be understood that each of the elements described above, or two or more together, may also find a useful application in other types of constructions differing from the types described above.

While the invention has been illustrated and described as embodied in apparatus for controlling a fuel cell device, and a fuel cell device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. An apparatus for controlling a fuel cell device for energy supply in a finished end product, comprising control means for an operation of the fuel cell device, said control means being formed so as to control control operational points in predetermined phases during the operation and to obtain an adjustable value of at least one device variable of the fuel cell device and to evaluate it with respect to at least one previously determined value of the device variable of the fuel cell device.

2. An apparatus as defined in claim 1, wherein said control means is formed so as to control the control operational points which are selected from the group consisting of control operational points which do not occur in a conventional operation and control operational points which occur only relatively seldom during a conventional operation.

3. An apparatus as defined in claim 1, wherein said control means is formed so that during an evaluation the at least one adjustable value of at least one device variable is compared with at least one previously determined comparison value of the device variable.

4. An apparatus as defined in claim 3, wherein said control means is formed so that in case of deviation of the at least one adjustable value from at least one comparison value of the device variable a correction measure determined in accordance with the deviation is performed.

5. An apparatus as defined in claim 1, wherein said control means is formed so that the control operational points are controlled after one another in a predetermined sequence.

6. An apparatus as defined in claim 1, wherein said control means is formed so that during a deviation of the at least one adjustable value from a comparison value, a control of one or several farther controllable control operation points is maintained or a control of new control operational points is performed.

7. An apparatus as defined in claim 1, wherein said control means is formed so that action possibilities on the fuel cell device provided in the finished product by a user of the finished product can not be negatively affected by the controlling of the control operational points.

8. An apparatus as defined in claim 1, wherein said control means is formed for acting on such operational points which, with action possibilities on the fuel cell device provided by the user in the finished product, can not be controlled.

9. An energy supply system for a finished end product formed as a vehicle with a fuel cell drive, comprising a fuel cell device; and an apparatus for controlling the fuel cell device, said apparatus including control means for an operation of the fuel cell device, said control means being formed so as to control control operational points in predetermined phases during the operation and to obtain an adjustable value of at least one device variable of the fuel cell device and to evaluate it with respect to at least one previously determined value of the device variable of the fuel cell device.

10. An energy supply system as defined in claim 9; and further comprising additional components for controlling the control operational points, in which a fuel cell of the fuel cell device produces a predetermined current quantity.
